(19) United States
(12) Patent Application Publication
(10) Pub. No.: US 2014/0267066 A1
(43) Pub. Date: Sep. 18, 2014

(54) VEHICLE DASHBOARD DEVICE WITH A TOUCHABLE MOBILE REMOTE CONTROL

(71) Applicant: NOMOVOK CO. LTD., Taipei (TW)

(72) Inventor: Aki Kalevi Kolehmainen, Taipei (TW)

(73) Assignee: Nomovok Co. Ltd., Taipei (TW)

(21) Appl. No.: 13/826,985

(22) Filed: Mar. 14, 2013

(51) Int. Cl. G06F 3/041; G08C 17/02; G08C 23/04; G08C 19/00

(52) U.S. Cl. CPC G06F 3/041; G08C 19/00; G08C 17/02; G08C 23/04
USPC 345/173

(57) ABSTRACT

A dashboard device includes a dashboard display and a touchable remote control. The dashboard display is divided into controllable area and visual area. The mobile remote control includes a touch surface without a display and is adapted to an electronic device with a display. Each touch event on the touch surface is reflected on the controllable area of the dashboard display directly relative to the position and nature of the event on the touch surface. The size of the touch surface is small enough so that user's fingers can be around it and his thumb to reach all corners of the area without moving the rest of the hand. The driver would know the relatively position of his finger on the touch surface without gazing at it for safety during driving. The touch surface can also be removed and given to a passenger for infotainment purposes. While detached, its functionality is reduced for security reasons.

### BACKGROUND OF THE INVENTION

1. Field of the Invention

This invention relates to vehicle information displays (also known as instruments, dashboards, panels, clusters, gauges), and particularly, to a dashboard device with a touchable remote mobile control.

2. Related Art

As is known, currently used vehicle display devices comprise analog or digital on-vehicle instruments normally indicating quantities such as vehicle speed, engine speed, fuel level, etc.; and a number of optical indicators showing various vehicle states, such as lights on, engine oil level, cooling water temperature, etc.

Most analog instruments comprise, for each display quantity, a needle gauge showing the value of the quantity on a graduated scale normally having a number of numeric characters, the size, and style of which are determined at the instrument design stage, while optical indicators normally comprise standard rear-lighted graphic symbols, each indicating a respective vehicle state.

Most digital instruments comprise, for each display quantity, an indicator comprising an LCD (Liquid Crystal Display) or a number of light-emitting elements (LEDs), which may be illuminated selectively to form a numeric character indicating the value of the quantity in a respective unit of measurement, or sequentially to indicate the level of the quantity on a graduated scale similar to that of analog instruments.

Vehicles typically include features such as instrument panels, audio systems, climate control systems, navigation systems, and other vehicle features. Many vehicle features are independent of each other. For example, vehicles typically have one set of controls for the climate control system and a separate set of controls for the audio system.

Recently, some manufacturers have implemented to integrate these systems in a single display, especially in a dashboard. However, it still lacks a good way to control the content on the dashboard.

### SUMMARY OF THE INVENTION

To solve the aforementioned problems of the prior art, the present invention provides a dashboard device having a touchable remote mobile control with a good way to control the content on the dashboard.

Accordingly, the present invention discloses a vehicle dashboard device including a dashboard display and a touchable remote control. The dashboard display is divided into a visual area and a controllable area. The visual area provides a visual display of information related to vehicle use and the controllable area provides at least one controllable content. The controllable area can be controlled using the touchable remote control. The touchable remote control includes a touch surface and a processor. The touch surface without a display is configured to receive a user input. The processor is configured to generate a control signal in response to the user input and send the control signal to the dashboard display for control the controllable content. The control signal is sent to control the same position relative to the controllable area of the dashboard display with the position of the user input relative to the touch surface.

The size of the touch surface is small enough so that user's thumb can easily reach its all corners without changing the position of the hand itself. The sensitivity of the palm makes it possible for user to know the relative position of his finger on the touch surface without having to gaze it and thus avoiding compromising the driving safety.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein for illustration only, and thus is not limited to the present invention, and wherein:

FIGS. 1 and 2 are respective views of the dashboard device in accordance with the present invention;

FIG. 2 is block diagram of the mobile remote control in accordance with the present invention;

FIGS. 3 to 5 are respective views of the dashboard device when utilizing in embodiments in accordance with the present invention;

FIGS. 6 and 7 are respective views of using methods for tilting the touch surface from portrait to landscape in accordance with the present invention;

FIG. 8 is respective view of the dashboard device when the remote control is detached in accordance with the present invention;

FIG. 9 are respective views of another embodiments of using methods for the mobile remote control of the dashboard device in accordance with the present invention; and

FIG. 10 is block diagram of the dashboard device in accordance with the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

Please refer to FIG. 1. The vehicle dashboard device including a dashboard display 20 and a touchable remote control 10. The dashboard display 20 shows the vehicle information, such as vehicle speed, engine speed, fuel level, lights on, engine oil level, cooling water temperature, etc. The mobile remote control 10 is disposed on the steering wheel 30 and includes a touch surface 11 without a display. The Steering wheel 30 here is only for schematic purposes. The mobile remote control 10 is detachable and may be detached and given to a passenger or placed on the driver's palm, please see FIG. 8. Also, the mobile remote control 10 may be attached on anywhere of the steering wheel 30 according to the user's habit or requirement.

The mobile remote control 10 has a size suitable for a user to operate by a single finger, preferably by this thumb. The mobile remote control 10 is generally rectangular and has the size 2.5 to 3.5 inches by 1.5 to 3.0 inches. The size of the touch surface 11 is small enough so that user's fingers can be around it and the thumb to reach all corners of the area without moving the rest of the hand. The sensitivity of the palm makes it possible for user to know the relatively position of his finger on the touch surface 11 without gazing at it. Area around the touch surface 11 is slightly above the touch surface 11 so that the boundary of the touch surface 11 is easily recognized by his finger.

Please see FIG. 10. The mobile remote control 60 is adapted to control the dashboard display 50 with a controllable content 51. The mobile remote control 60 includes a touch surface 61, a processor 62, a transmitter 63, a battery 64, and a memory 65. The dashboard display 50 includes a controllable content 51, a processor 52, and a receiver 53. The touch surface 61 is configured to receive a user input. The processor 62 is configured to generate a control signal in response to the user input and send the control signal by the transmitter 63 to the dashboard display 50. The dashboard display 50 receives the control signal by the receiver 53. The control signal is sent by using one or more of wireless communication methods including wireless local area network (WLAN), Bluetooth, Zigbee, wireless broadband (WiBro) internet, wireless universal serial bus (WUSB), radio frequency identification), and infrared data association (IrDA) technologies. When the dashboard display 50 receives the control signal, the processor 52 would control controllable content 51 to be executed.

Please refer to FIG. 2, the touchable remote control 10 includes a control button 12 to control the controllable area 21 of the dashboard display 20. The dashboard display 20 can be divided into a visual area 201 and a controllable area 21. The visual area 201 provides a visual display of information related to vehicle use, such as vehicle speed, engine speed, fuel level, lights status, engine oil level, cooling water temperature, etc. The controllable area 21 provides at least one controllable content, such as audio systems 25, climate control systems 23, navigation systems 22, communication systems 24, and other vehicle controllable features.

Please see FIGS. 3 and 10. The touch surface 11(61) has substantially the same shape as the controllable area 21 of the dashboard display 20(50) and has a different size. When the dashboard display 20(50) receives the control signal, the processor 52 would control the same position relative to the controllable area 21 of the dashboard display 20(50) with the position of the user input relative to the touch surface 11(61). As shown in the FIG. 3, there may be four controllable contents, for example. When the user taps the bottom right block of the touch surface 11 of the mobile remote control 10, the dashboard display 20 will receive a control signal to execute the bottom right controllable content of the controllable area 21, i.e. the navigation systems 22. Note that the touch surface 11 of the mobile remote control 10 does not have the dotted line. It is only shown to explain the above operation. For example, if the bottom right controllable content is navigation systems 22, tapping the bottom right area of the remote control executes the navigation systems 22, please refer to FIG. 4. The touch surface itself has no display of its own. It is also noted that there is no pointer on the dashboard display 20. All actions rely on user's ability to match the location on the touch surface 11 to the relative location on the controllable area 21 of the dashboard display 20. As another example, when the user taps the bottom left block of the touch surface 11 of the mobile remote control 10, the dashboard display 20 will receive a control signal to execute the bottom left controllable content of the controllable area 21, i.e. the audio systems 25, see FIG. 5.

Controllable area 21 can be hidden, shown and split in two using a control button 12, please refer to FIG. 7. In case the area for controllable area 21 is split in two, the control button 12 may be pushed left/right to move to the next/previous controllable content. Please refer to FIG. 6, the touchable remote control 10 includes a hook 13 to rotate the touch surface 11. User can tilt the touch surface 11 from portrait to landscape position by pulling the rounded hook 13 on the side by a single finger. When the touch surface 11 tilts, the controllable area 21 tilts also to the respective position. Regardless of the position, the driver's thumb can reach all parts of the touch surface 11 without driver having to let his hand off from the steering wheel 30.

Driver can initiate two controllable contents using single click the control button 12. Please refer to FIG. 7, when a new controllable content, the communication systems 24, is opened, it first shows the controllable area 21 of the dashboard display 20. Upon opening, smoothly moving the old one, the navigation systems 22, to one side. Also, if the old one, the navigation systems 22, was landscape, smoothly putting it to portrait. Furthermore, the new controllable content, the communication systems 24, may be opened automatically, such as when a phone call is coming. In case the touchable remote control is detached from the wheel for passenger usage, this action is not available, see FIG. 8, and the controllable area remains in the state it was when the remote control was detached.

A push of the control button 12 toggles focus between the two controllable contents. Active controllable content may be marked by a border that slides smoothly from a controllable content over the other. The inactive controllable content, the communication systems 24, is closed automatically when the active controllable content, the navigation systems 22, is turned into landscape, please refer to FIG. 9. The inactive controllable content, the communication systems 24, is also closed when user clicks the button in the control button 12. Double-click of the button smoothly hides the controllable area altogether leaving all available dashboard space for the visual area 201 alone. Another double-click shows the controllable area again. In case the touchable remote control 10 is detached from the wheel 30 for passenger usage, these actions are not available, see FIG. 8.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A vehicle dashboard device, comprising:
a dashboard display, divided into a visual area and a controllable area, the visual area providing a visual display of information related to vehicle use and the controllable area providing at least one controllable content; and
a touchable remote control, configured to control the controllable content of the dashboard display, comprising:
a touch surface without a display, configured to receive an user input; and
a processor, configured to generate a control signal in response to the user input and send the control signal to the dashboard display for control the controllable content.

2. The vehicle dashboard device of claim 1, wherein the control signal is sent by using one or more of wireless communication methods including wireless local area network (WLAN), Bluetooth, Zigbee, wireless broadband (WiBro) internet, wireless universal serial bus (WUSB), radio frequency identification), and infrared data association (IrDA) technologies.

3. The vehicle dashboard device of claim 1, wherein the control signal is sent to control a same position relative to the controllable area of the dashboard display with a position of the user input relative to the touch surface.

4. The vehicle dashboard device of claim 1, wherein the touchable remote control is disposed on a steering wheel.

5. The vehicle dashboard device of claim 4, wherein the touchable remote control is detachable from the steering wheel.

6. The vehicle dashboard device of claim 1, wherein the touchable remote control includes a hook to rotate the touch surface.

7. The vehicle dashboard device of claim 6, wherein the controllable area of the dashboard display is rotated according to the touch surface.

8. The vehicle dashboard device of claim 1, wherein the touchable remote control is generally rectangular and has the size 2.5 to 3.5 inches by 1.5 to 3.0 inches.

9. The vehicle dashboard device of claim 1, wherein the touchable remote control includes a control button to control the visibility and state of the controllable area.

10. A touchable remote control, adapted for a dashboard display of a vehicle to control at least one controllable content thereon, comprising:
a touch surface without a display, disposed on a steering wheel of the vehicle and configured to receive an user input; and
a processor, configured to generate a control signal in response to the user input and send the control signal to the dashboard display for control the controllable content.

11. The touchable remote control of claim 10, wherein the control signal is sent by using one or more of wireless communication methods including wireless local area network (WLAN), Bluetooth, Zigbee, wireless broadband (WiBro) internet, wireless universal serial bus (WUSB), radio frequency identification), and infrared data association (IrDA) technologies.

12. The touchable remote control of claim 10, wherein the control signal is sent to control a same position relative to the dashboard display with a position of the user input relative to the touch surface.

13. The touchable remote control of claim 10, wherein the touchable remote control is detachable from the steering wheel.

14. The touchable remote control of claim 10, wherein the touchable remote control includes a hook to rotate the touch surface.

15. The touchable remote control of claim 14, wherein the controllable content of the dashboard display is rotated according to the touch surface.

16. The touchable remote control of claim 10, wherein the touchable remote control is generally rectangular and has the size 2.5 to 3.5 inches by 1.5 to 3.0 inches.

17. The touchable remote control of claim 10, wherein the touchable remote control includes a control button to control the visibility and state of the controllable area.
